(19) United States
(12) Patent Application Publication
(10) Pub. No.: US 2012/0095930 A1
(43) Pub. Date: Apr. 19, 2012

(54) PRODUCT CERTIFICATION SYSTEM AND METHOD

(76) Inventors: Gene Rider, Oak Brook, IL (US); Karen Ng, Kowloon (HK); Joseph Mohorovic, Glen Ellyn, IL (US); Xiao Chen, Naperville, IL (US); Ruben Suarez, Plainfield, IL (US); Mark Mrozek, Chicago, IL (US); Brian Check, Wheeling, IL (US); Stephanie Fok, Naperville, IL (US); Erick Ramos, Chicago, IL (US)

(21) Appl. No.: 13/333,262

(22) Filed: Dec. 21, 2011

Related U.S. Application Data
(63) Continuation of application No. PCT/US11/54201, filed on Sep. 30, 2011.
Application No. PCT/US11/54201 is a continuation of application No. 12/986,876, filed on Jan. 7, 2011.
(60) Provisional application No. 61/389,066, filed on Oct. 1, 2010.
(60) Provisional application No. 61/410,585, filed on Nov. 5, 2010.
(60) Provisional application No. 61/431,358, filed on Jan. 10, 2011.

(51) Int. Cl. G06Q 99/00

(52) U.S. Cl. 705/317

(57) ABSTRACT

Systems and methods are provided for generating a certificate of compliance for a product. A product control system (PCS) retrieves specification and/or regulatory data for a particular product and compares the retrieved data to test result data obtained for that particular product. The PCS generates a product certification if the test result data indicates that the product is in compliance with the specification data and/or the regulatory data. A product test plan generation system (PTPGS) enables a user to interact with a user interface to retrieve a test plan for a particular product. The test plan can be used to obtain test results for the particular product.

### CROSS-REFERENCE TO RELATED APPLICATIONS

The present application is a continuation of International Application No. PCT/US11/54201, filed on Sep. 30, 2011, which claims the benefit of U.S. Provisional Patent Application No. 61/389,066, filed on Oct. 1, 2010, U.S. Provisional Patent Application No. 61/410,585, filed on Nov. 5, 2010, U.S. application Ser. No. 12/986,876, filed on Jan. 7, 2011, and U.S. Provisional Application No. 61/431,358 filed on Jan. 10, 2011, the contents of all of which are hereby incorporated by reference.

### BACKGROUND

Multiple businesses and/or entities can be involved in the manufacture of a particular good or product. These multiple entities or businesses may be a part of a supply chain, which is a system of organizations, people, technology, activities, information, and resources involved in moving a good or product from a manufacturer to customer. The supply chain may only include domestic entities or may include both foreign and domestic entities.

For example, the globalization of trade and manufacturing processes has resulted in many businesses being involved in an international supply chain of goods. A given manufacturer frequently obtains assembly components from suppliers or importers located in various countries and each of the suppliers, in turn, may obtain subcomponents from suppliers in other countries, and so on. It is the norm that products may have subcomponents made in various countries. Coupled with the prevalence of just-in-time' inventory management, timely international shipping of parts is a critical aspect of maintaining orderly and efficient supply chain management. Facilitating importation of such shipments is critical to modern manufacturing processes and providing an efficient global trade economy.

However, importing goods of a shipment is a complicated process involving many regulations that vary from country to country. For example, many countries restrict the type of goods that can be imported under the auspices of international trade agreements or unilateral regulation by the importing country. Special permits may be required for importing particular type of goods into a country or shipping or manufacturing particular type of goods within that country. Moreover, different countries may have different regulations with respect to the composition of a particular good being imported. As a result, companies that import or receive goods from another country must be able to verify compliance with such rules and regulations. Similarly, companies that ship or manufacture goods domestically within a particular country must be able to verify compliance with the rules and regulations of that country.

While there are conventional applications for obtaining, storing, processing, and communicating product data using the known hardware and software technologies available, no such systems or configurations exist for obtaining, managing, processing, and communicating product data in a manner that effectively verifies regulatory compliance of goods traveling into, out of, or within one or more countries along a supply chain. Furthermore, there lacks known means to effectively link such information in real time among numerous entities within a supply chain in a cooperative and useful manner.

### SUMMARY

According to one aspect, a certification application includes modules that are executable by a processor, to conduct product certification. The certification application includes a product input module to receive product identification data for a particular product from a first party in a supply chain. A manufacturer input module receives product specification data for the particular product from a second party in the supply chain, the product specification data defining a product characteristic. The certification module includes a test identification module to receive test result data for the particular product from a third party in the supply chain, the test result data defining a result of a test for a test product having product characteristics matching the particular product. A certificate generation module generates a certificate for the particular product, when the result is a passing result.

According to another aspect, a method is provided for conducting product certification. The method includes receiving, at a processor, product identification data for a particular product from a first party in a supply chain. The method includes receiving, at the processor, product specification data for the particular product from a second party in the supply chain, the product specification data defining a product characteristic. The method further includes receiving, at the processor, test result data for the particular product from a third party in the supply chain, the test result data defining a result of a test for a test product having product characteristics matching the particular product. The method also includes generating, at the processor, a certificate for the particular product, when the result is a passing result.

In yet another aspect, a system for generating a product testing plan is provided. The system includes a database comprising product test parameters for a plurality of products. The system is capable of executing a product test application comprising modules executable by a processor. The product test application includes a product input module to receive product component data for a particular product, the product component data defining at least one product component characteristic. A test generation module queries the database to identify product test parameters corresponding to the at least one product component characteristic and generate a product testing plan based on the identified product test parameters corresponding to the at least one product component characteristic.

In another aspect, a method is provided for generating a product testing plan. The method includes receiving, at a processor, product component data for a particular product, the product component data defining at least one product component characteristic. The method also includes querying, at the processor, a database comprising product test parameters for a plurality of products the database to identify product test parameters corresponding to the at least one product component characteristic. The method further includes generating, at the processor, a product testing plan based on the identified product test parameters corresponding to the at least one product component characteristic.

### BRIEF DESCRIPTION OF THE FIGURES

FIGS. 1A-1E are block diagrams of computing environments for implementing a product certification system in accordance with an aspect of the present invention.

FIG. 2 is a block diagram of a product certification system in accordance with one aspect of the present invention.

FIG. 3 is a block diagram of a product test plan generation system in accordance with an aspect of the present invention.

FIG. 4 is an exemplary product data input form data input form.

FIG. 5 is an exemplary manufacturer input form.

FIG. 6 is an exemplary tester input form.

FIG. 7 is an exemplary product test plan generation form.

FIG. 8A is a flow chart illustrating a method for certifying a product.

FIG. 8B is another flow chart illustrating a method for certifying a product.

FIG. 9 is a flow chart illustrating a method for generating a product testing plan.

FIG. 10 is a block diagram of a product test plan generation system in accordance with one aspect of the present invention.

FIGS. 11-19 are exemplary screen shots of various data entry forms.

### DETAILED DESCRIPTION

The terminology used herein is for the purpose of describing particular embodiments only and is not intended to be limiting. Some terms have been given a specific meaning.

a. Computing Device—a computing device refers to a computing or processing device, such as a personal computer, a server computer, or a mobile processing device. Each computing device includes one or more processors that process software or other machine-readable instructions and includes memory to store the software or other machine-readable instructions and data. The memory may include volatile and/or non-volatile memory. Each computing device also may include a communication system to communicate via wireline and/or wireless communications, such as through the Internet, an intranet, an Ethernet network, a wireline network, a wireless network, and/or another communication network. Each computing device may include a display, such as a computer monitor, for viewing data, and an input device such as a keyboard or a pointing device (e.g., a mouse, trackball, pen, touch pad, or other device), for entering data. Each computing device can be used by a corresponding user to retrieve product data from and/or supply product data.

b. Computer readable medium—a computer readable media (“CRM”) is considered to include memory, volatile media, nonvolatile media, removable media, and non-removable media. For example, a CRM may include computer storage media. Computer storage media may include memory, volatile media, nonvolatile media, removable media, and/or non-removable media implemented in a method or technology for storage of information, such as a computer readable instructions, data structures, program modules, or other data.

c. Communication Network—a communication network is a network such as a local area network, or a wireless local network. Additionally, communication network may refer to a wide area network, or the Internet.

d. Database—a database is a general repository of data including but not limited to product data, product identification data, product specification data, test result data and/or other data relating to a product and/or the manufacturing of a product. The database may include memory and one or more processors or processing systems to receive, process, query and transmit communications and store and retrieve data. In another aspect, the database may be a database server.

e. Administrator—an administrator may be one who administers, especially one who works as a manager in a business. For example, in a manufacturing business. The administrator may be a person who manages a computer, a network or specific software components and have rights to perform all operations in the computer relating to the business.

Aspects of a product certification system (PCS) described herein provide the ability to collect disparate data associated with a product and/or good in a supply chain. For example, the PCS enables the collection and storage of disparate data, such as product identification data, raw material data, test result data, specification data, and/or regulatory data. The PCS also enables the dynamic generation a product certification based on the disparate data.

Another aspect of the PCS enables generating a certificate of compliance for a product or good by comparing one or more types of the disparate data to one or more other types of disparate data. For example, the PCS may retrieve specification and/or regulatory data for a particular product based on the identification data for that particular product. The PCS then compares, for example, test result data for the particular product to the retrieved specification data and/or the regulatory data to determine whether the product complies with the specification data and/or the regulatory data. If the product complies with the specification data and/or the regulatory data, the PCS generates a product certification.

Aspects of a product test plan generation system (PTPGS) described herein provide the ability to define and retrieve product test parameters corresponding to a product and/or good in a supply chain. For example, the PTPGS includes a database that store predefined test parameters for various products and/or various components of products.

Another aspect of the PTPGS enables a user to interact with a graphical user interface to enter a particular product or a product component for which a test plan is desired. The PTPGS then queries to a database to retrieve product test parameters corresponding to the particular product or a product component entered by the user. The test parameters can be used to obtain test results for the particular product or product components. For example, the test parameters can be used to verify whether one or more characteristics of the particular product or are within the corresponding test parameters.

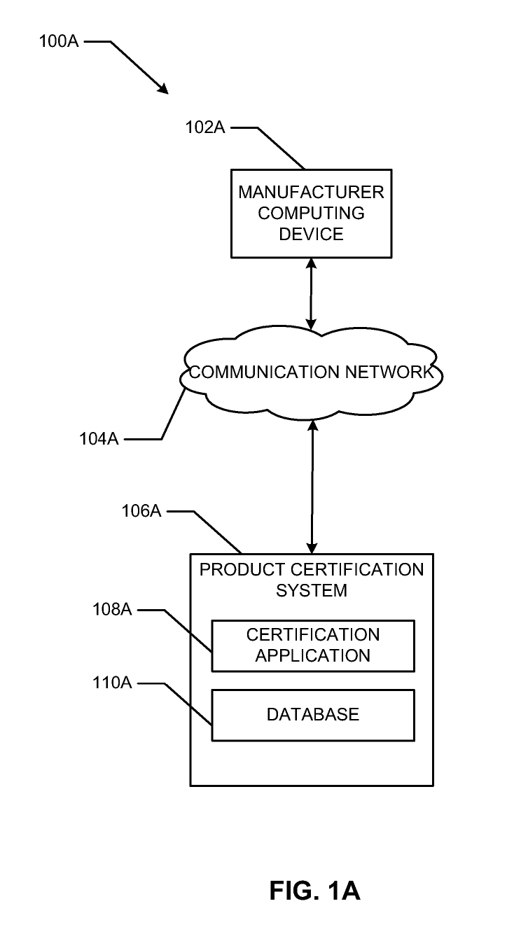

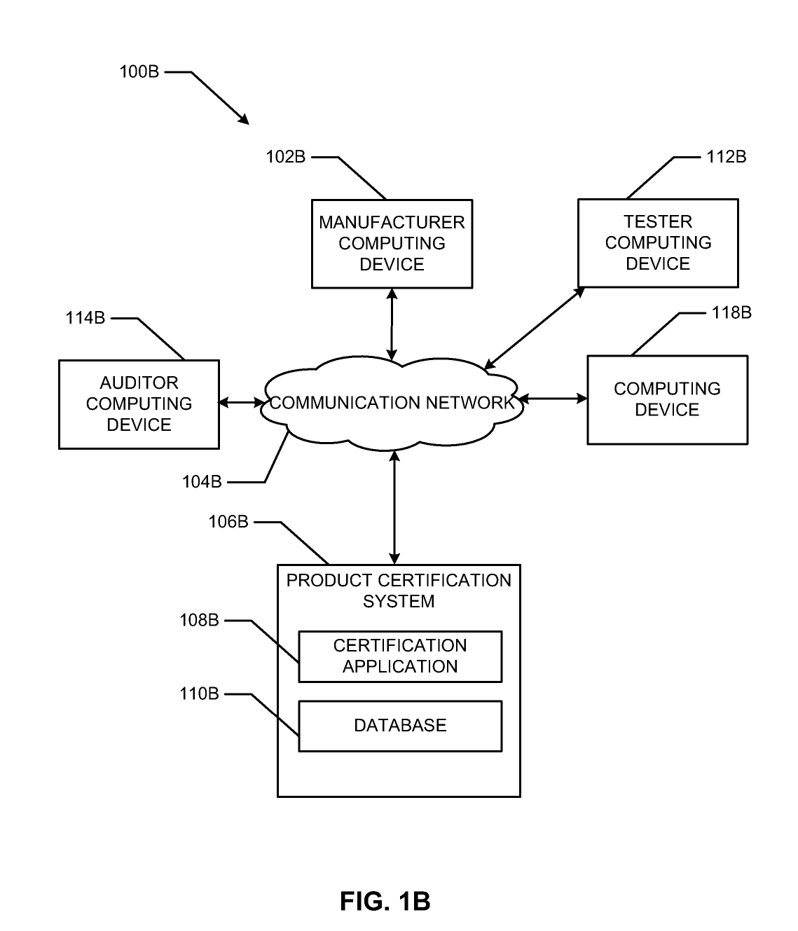

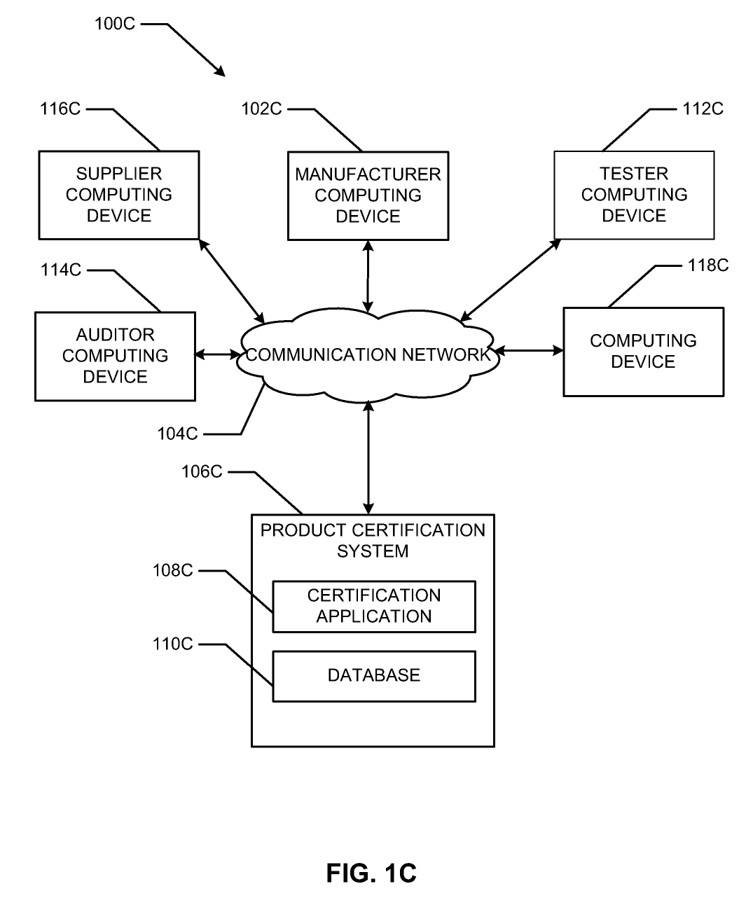

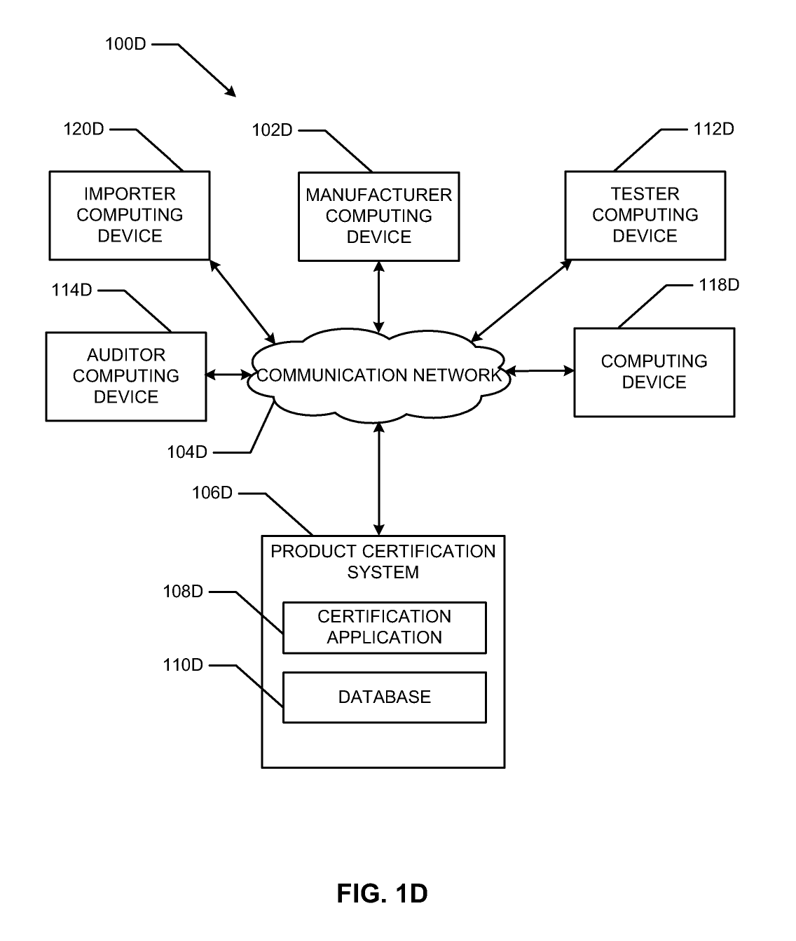

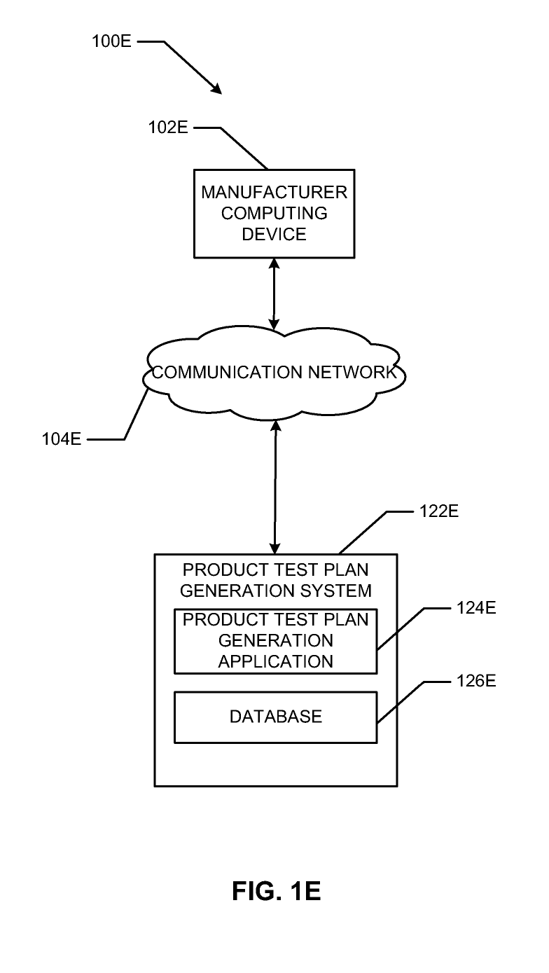

FIG. 1A is a block diagram of an exemplary computing environment 100A for certifying products in a supply chain according to an aspect of the present invention. The computing environment 100A includes a manufacturer computing device 102A and a product certification system (PCS) 106A. Although the computing environment 100A is described herein primarily in connection with a single manufacturer computing device 102A, it is contemplated that the computing environment 100A may include multiple manufacturer computing devices.

The PCS 106A executes a certification application 108A to enable a user to generate one or more data entry request and/or to generate a certificate for a particular product. According to one aspect, after executing the certification application 108A various hyperlinks are displayed via a display associated with the computing device. Each of the hyperlinks is linked, for example, to different data entry forms that are associated with products and/or goods in a supply chain. Thus, by selecting a particular hyperlink, the user is linked to a corresponding form that can be displayed to the user.

According to one aspect, the manufacturer computing device 102A is communicatively connected to the PCS 106A through a communication network 104A. In another embodiment, the manufacturer computing device 102A is coupled or communicatively connected to the PCS 106A from a remote location, such as by a wide area network, or via the Internet. Various levels of access to the computing environment 100A may be provided through a password and user ID system as is known in the art.

In one aspect, the manufacturer computing device 102A is associated with a manufacturer in a manufacturing supply chain, product development supply chain, etc. In general, a supply chain refers to a system of organizations, people, technology, activities, information and/or resources involved in moving a consumer product or service from a manufacturer to a customer. For example, a supply chain may include: a manufacturer and/or supplier, a product tester, a product auditor, a product importer, and a customer. In another aspect, the manufacturer computing device 102A may be associated with one or more parties in the supply chain.

According to another aspect, a first administrator representing a manufacturer uses the manufacturer computing device 102A to generate a manufacturer data entry request to transmit to the PCS 106A. According to one aspect, the manufacturer data entry request is generated in response to the first administrator selecting a hyperlink that corresponds to manufacturer product data entry form. A hyper link is a reference to a source document that the reader can directly follow. For example, a hyperlink may consist of an underlined word or phrase, such as “Product Descriptions,” displayed on a web page which when selected and/or activated by a user will direct the user to a source document related to particular products produced by a manufacturer. The PCS 106A transmits the manufacturer product data entry form to display at the manufacturer computing device 102A in response to the manufacturer data entry request. The first administrator then uses, for example, the keyboard associated with the manufacturer computing device 102A to interact with the product data entry form to enter manufacturing product data, such as product specification data. For example, product specification data may include data that describes the characteristics of a particular product. After entering the manufacturing product data, the first administrator uses the input device to select an input control, such as a submit control button, displayed on the manufacturer product data entry form to transmit the product identification data to the PCS 106A.

According to another aspect, a second administrator representing the manufacturer may use the manufacturer computing device 102A to generate a product data entry request to transmit to the PCS 106A. According to another aspect, the product data entry request is generated in response to the second administrator selecting another hyperlink that corresponds to a product identification data entry form. The PCS 106A transmits the product identification data entry form to display at the manufacturer computing device 102A in response to the product data entry request. The second administrator then uses the keyboard associated with the manufacturer computing device 102A to interact with the product identification data entry form to enter product data, such as product identification data. For example, product identification data may include data that generally describes a product. After entering the product data, the second administrator uses the input device to select an input control, such as a submit control button, displayed on product data entry form to transmit the product identification data to the PCS 106A.

In another aspect, a third administrator representing the manufacturer may use the manufacturer computing device 102A to generate a tester data entry request to transmit to the PCS 106A. According to another aspect, the tester data entry request is generated in response to the third administrator selecting another hyperlink that corresponds to a tester product data entry form. The PCS 106A transmits the tester product data entry form to display at the manufacturer computing device 102A in response to the tester data entry request. The third administrator then uses the input device associated with the manufacturer computing device 102A to interact with the tester product data entry form to enter product data, such as test result data. For example, test result data may include data indicating whether a product passed or failed a required test. After entering the product data, the third administrator uses the input device to select an input control, such as a submit control button, displayed on product data entry form to transmit the product identification data to the PCS 106A.

According to another aspect, a fourth administrator representing the manufacturer may use the manufacturer computing device 102A to enter product data such as raw material product data. In one aspect, raw material product data may refer to materials that are in an unprocessed or minimally processed state. In another aspect, raw materials may refer to the materials or components used in a manufacturing process to create a manufactured product. For example, the fourth administrator interacts with the manufacturer computing device 102A to generate the raw material/product component data entry request to transmit to the PCS 106A. According to one aspect, raw material/product component data entry request is generated in response to the fourth administrator selecting another hyperlink that corresponds to a raw material/product component data form. The PCS 106A transmits the raw material/product component data form to display at the manufacturer computing device 102A in response to the raw material/product component data entry request. The fourth administrator then uses, for example, the keyboard associated with the manufacturer computing device 102A to interact with the raw material/product component data form to enter raw material/product component data. After entering the raw material/product component data, the user uses the input device to select an input control, such as a submit control button, displayed on the raw material/product component data form to transmit the raw material/product component data to the PCS 106A.

The PCS 106A executes a certification application 108A to generate a certificate for the particular product. For example, the certification application 108A collects product identification data, product specification data, and test result data for particular product and then generates a certificate for that particular product based on at least one of test product identification data, product specification data, and test result data. The certification application 108A stores the product identification data, the product specification data, the test result data, and a record of the certificate for particular product in the database 110A.

According to another aspect, a fifth administrator may use the manufacturer computing device 102A to generate an auditor data request. According to one aspect, the auditor data request is generated in response to the fifth administrator selecting another hyperlink that linked to the database 110A. The hyperlink is, for example, displayed on an audit form (not shown). The PCS 106A transmits various product data from the database 110A, such as test result data, product specification data, product identification data, and certification data for a particular product or group of products to the manufacturer computing device in response to the auditor data request.

Although the manufacturer computing device is described as being used by five different administrative users, it is contemplated that in one aspect, a single administrator may have the authority to interact with the various forms described above.

FIG. 1B is a block diagram of an optional computing environment 100B for certifying products in a domestic supply chain. As used herein, domestic supply chain refers to a supply chain within a single country. The computing environment includes a manufacturer computing device 102B, a product certification system (PCS) 106B, a tester computing device 112B, and an auditor computing device 114B. In this example, the tester computing device 112B and the auditing computing device 114B may be used to enter product data and/or other data related to products in a supply chain in addition to the manufacturer computing device 102B. Although the computing environment is described herein primarily in connection with computing devices 102B, 112B, and 114B, it is contemplated that the computing environment may include at least one additional computing device 118B.

For example, a manufacturer may optionally interact with the manufacturer computing device 102B to enter product data, such as product identification data. In this embodiment, the manufacturer computing device operates similarly to the manufacturer computing device 102A described above in connection with FIG. 1A.

In another aspect, a tester may optionally interact with the tester computing device 112B to enter product data, such as test result data. In this embodiment, the tester uses the tester computing device to access a tester product data entry form for submitting test result data. The tester computing device 112B operates similarly to the manufacturer computing device 102A described above in connection with FIG. 1A, when using the tester product entry form and entering test result data.

In another aspect, an auditor may optionally interact with the auditor computing device 114B to generate an auditor data request and receive product data, such as test result data, product specification data, product identification data, and certification data for a particular product or group of products. The auditor computing device 114B operates similarly to the manufacturer computing device 102A described above in connection with FIG. 1A, when generating an auditor data request.

FIG. 1C is a block diagram of another optional computing environment 100C for certifying products in a domestic supply chain. The computing environment 100C includes a manufacturer computing device 102C, a product certification system (PCS) 106C, a tester computing device 112C, an auditor computing device 114C, and a supplier computing device 116C. Although the computing environment 100C is described herein primarily in connection with computing devices 102C, 112C, and 114C, it is contemplated that the computing environment may include at least one additional computing device 118C.

In this example, a supplier uses the supplier computing device 116C to access a raw material/product component data form to enter product data such as raw material product data. In this embodiment, the supplier computing device operates similarly to the manufacturer computing device 102A described above in connection with FIG. 1A, when using the raw material/product component data form to enter raw material product data.

FIG. 1D is a block diagram of an optional computing environment 100D for certifying products in a supply chain according an aspect of the present invention. The computing environment 100D includes a manufacturer computing device 102D, a product certification system (PCS) 106D, a tester computing device 112D, an auditor computing device 114D, and an importer computing device 120D. Although the computing environment 100D is described herein primarily in connection with computing devices 102D, 112D, 114D, 118D, and 120D, it is contemplated that the computing environment may include at least one additional computing device 118D.

According to another aspect, an importer uses the importer computing device 120D to access a product identification data entry form to enter product data such as product identification data. In this embodiment, the importer computing device 120D operates similarly to the manufacturer computing device 102A described above in connection with FIG. 1A, when using the product identification data entry form to enter product identification data.

FIG. 1E is a block diagram of another optional computing environment 100E for certifying products in a supply chain. The computing environment includes a manufacturer computing device 102E, a communication network 104E, and a product test plan generation system (PTPGS) 122E.

In other optional embodiments, it is contemplated that the PTPGS 122E may be used in conjunction with any of the computing environments 100A, 100B, 100C, and 100D illustrated above in connection with FIGS. 1A-1D, respectfully.

In one aspect, the PTPGS 122E may optionally execute a product test plan generation application 124E to generate a product testing plan. As an example, the product test plan generation application 124E receives product component data for a particular product from the manufacturer computing device 102E and queries a database 126E to identify corresponding product test parameters for that particular product. The corresponding product test parameters include, for example, relevant tests that can be used to certify that the product and/or product component data is in compliance with any applicable requirements and/or regulations. The corresponding product test parameters may also include a frequency of testing and a number of products to be tested. In other embodiments, it is contemplated that product component data for a particular product may be received from computing devices other than the manufacturer computing device.

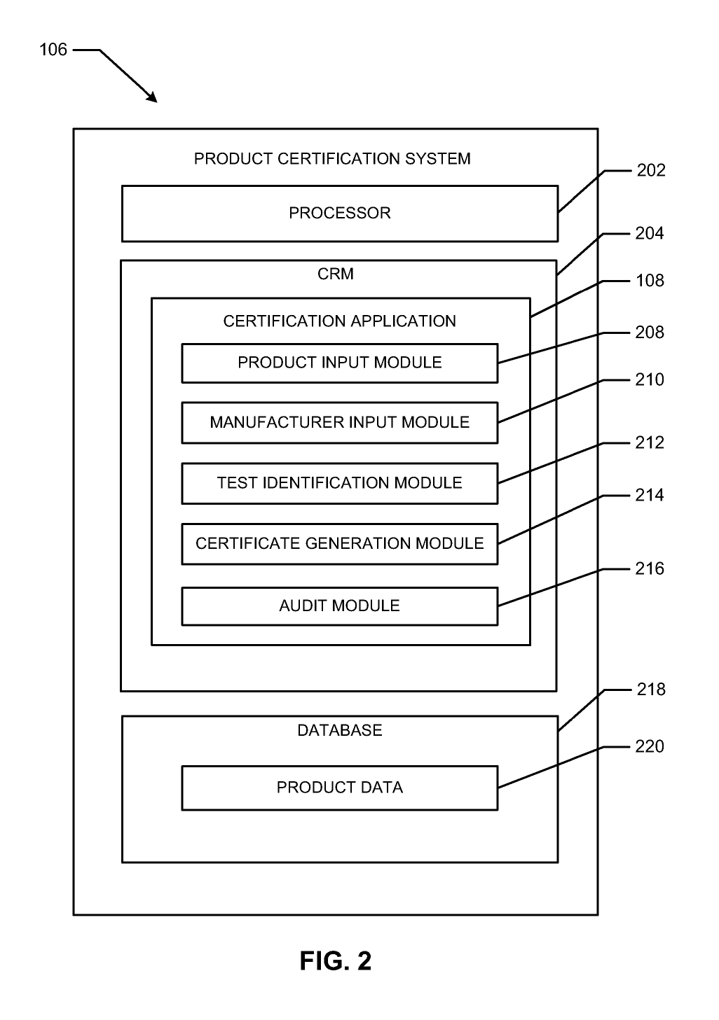

FIG. 2 is a block diagram that depicts an exemplary product certification system 106 (e.g., PCS 106A, PCS 106B, PCS 106C, or PCS 106D). According to one aspect, the product certification system 106 includes a processor 202 that executes the certification application 108 to generate a certificate for the particular product. The processor 202 may include memory as well as other computing components and may reside on a computer, or other processing system.

The PCS 106 may also include a computer readable media (“CRM”) 204 configured with the certification application 108 (e.g., product certification application 108A, product certification application 108B, product certification application 108C or product certification application 108D). The PCS 106 may include a database 218 to store product data 220 for a plurality of products.

According to one aspect of the invention, the certification application 108 includes instructions or modules that are executable by the processor 202. For example, in one embodiment, the certification 108 (e.g., certification application 108A, certification application 108B, certification application 108C, certification application 108D) includes a product input module 208, a manufacturer input module 210, a test identification module 212, a certificate generation module 214, and an audit module 216. Other modules may also be included.

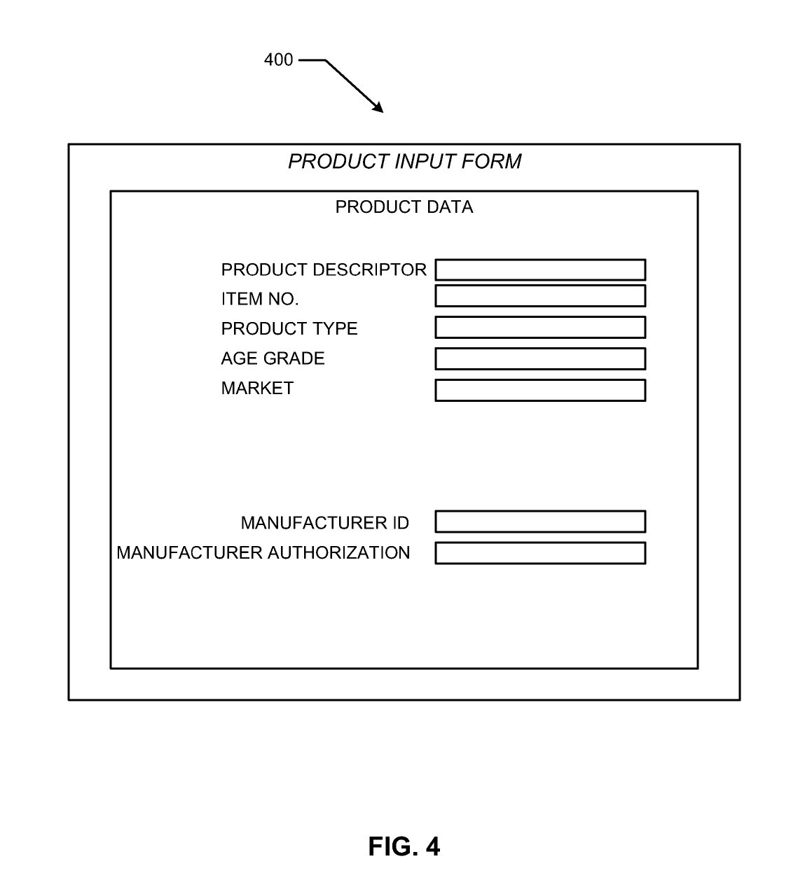

The product input module 208 receives product data, such as product identification data for a particular product from an importer or manufacturer and stores the data in the database 218. For example, in one aspect of the invention, the importer may input product identification data such as a product description, product type, product age grade, product market, product manufacturer, etc. In another example, the manufacturer enters product identification data. For purposes of illustration, an exemplary product input form (400) is depicted in FIG. 4.

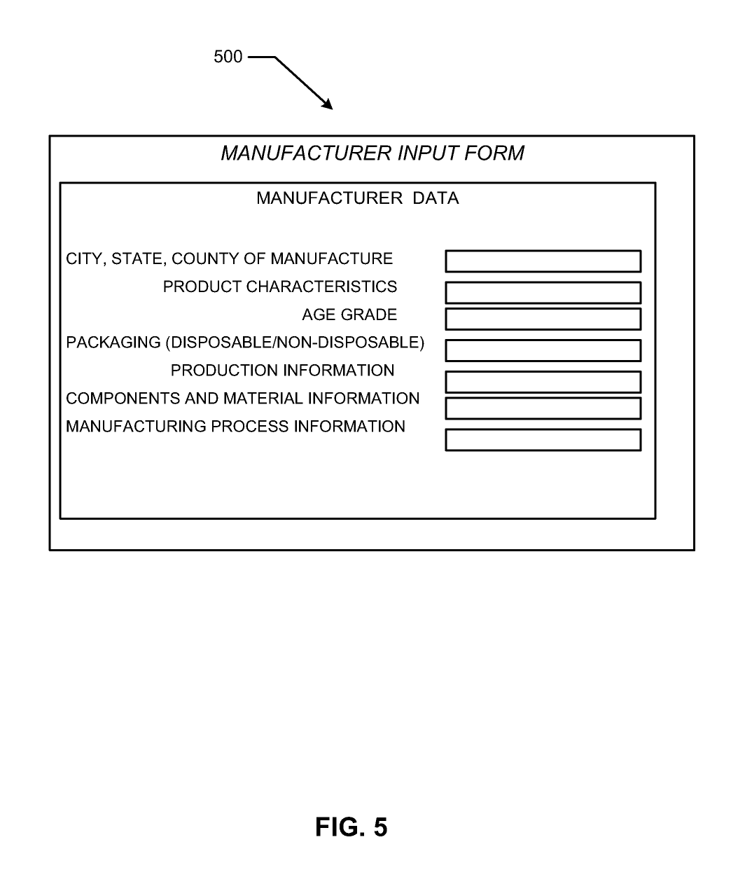

The manufacturer input module 210 receives product data, such as product specification data for a particular product from a manufacturer and/or supplier in the supply chain and stores the data in the database 218. For example, the manufacturer may input data such as product characteristic data, product age grade, product manufacturing process information, product components and materials, product quality management documentation, etc. In one aspect, product specification data defines a product characteristic, which defines a product feature or product manufacturing process. For example, if a shoe were defined as a product, the shoe may have product characteristics including: color, size, material, type, etc., as well as any manufacturing processes used to make the shoe. In another example, a supplier inputs product specification data such as product component and/or raw material data. For purposes of illustration, an exemplary manufacturer input form (500) is depicted in FIG. 5.

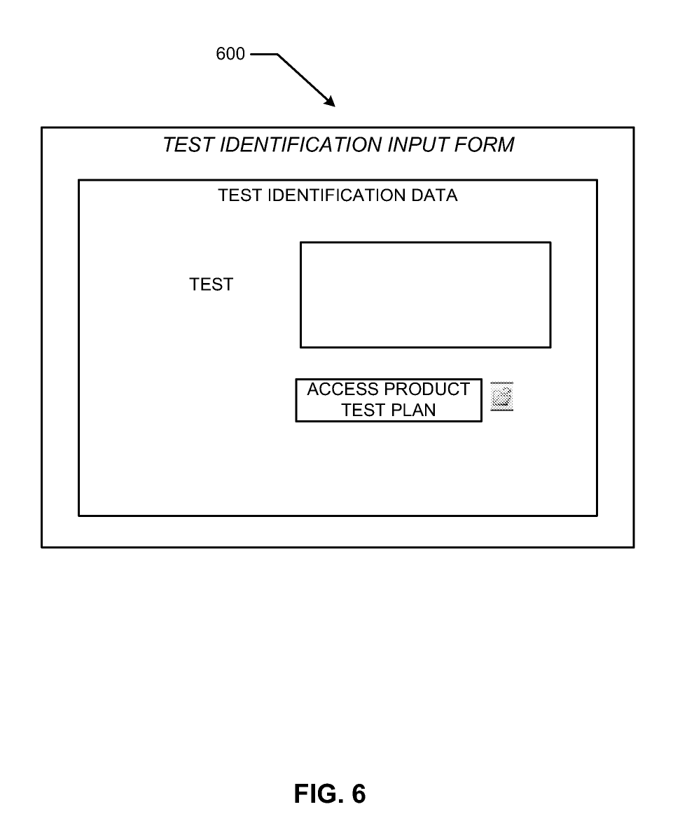

The test identification module 212 receives product data, such as test result data for a particular product from a tester and stores the data in the database 218. For example, the tester may input test result data such as the type of product tests performed, the number of products tested, and data indicating whether the tests were passed, etc. For purposes of illustration, an exemplary tester identification input form (600) is depicted in FIG. 6.

The certificate generation module 214 generates a certificate for a particular product when the test result data for the particular product indicates that the particular product passes a test associated with applicable product testing plan. According to one aspect, the test result data corresponds to a sampling or portion of products that are selected at random from a batch or volume of products being supplied along the supply chain. In other words, the applicable test for a particular product may only be applied to a test product or test products and not every product being supplied via the supply chain.

The audit module 216 transmits product data, such as test result data, product specification data, product identification data, and certification data for a particular product or group of products from the database 218 to the auditor computing device 114 in response to an audit request received from the auditor computing device 114. According to another aspect, the audit module 216 transmits product data from database 218 to any of computing devices 102, 112, 114, 116, 118, and 120 in response to a corresponding audit request received from computing devices 102, 112, 114, 116, 118, and 120.

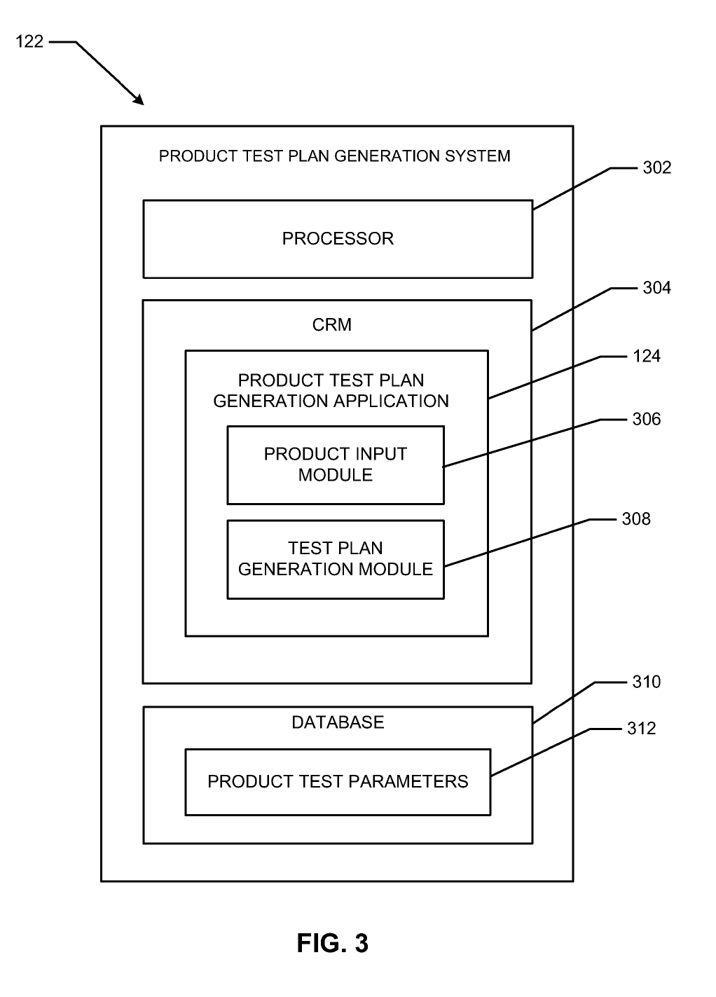

FIG. 3 is a block diagram that depicts an exemplary PTPGS 122 (e.g. PTPGS 122E). According to one aspect, the PTPGS 122 includes a processor 302 that executes the product test plan generation application 124 to generate a product testing plan for a particular product. The processor 302 may include memory as well as other computing components and may reside on a computer, or other processing system.

The PTPGS 122 may also include a computer readable media (“CRM”) 304 configured with the product test plan generation application 124. The PTPGS 122 may include a database 310 to store product data such as product test parameters 312 for a plurality of products.

According to one aspect of the invention, the product test plan generation application 122 includes instructions or modules that are executable by the processor 302. For example, in one embodiment, the product test plan generation application 122 includes a product input module 306 and a test plan generation module 308. Other modules may also be included.

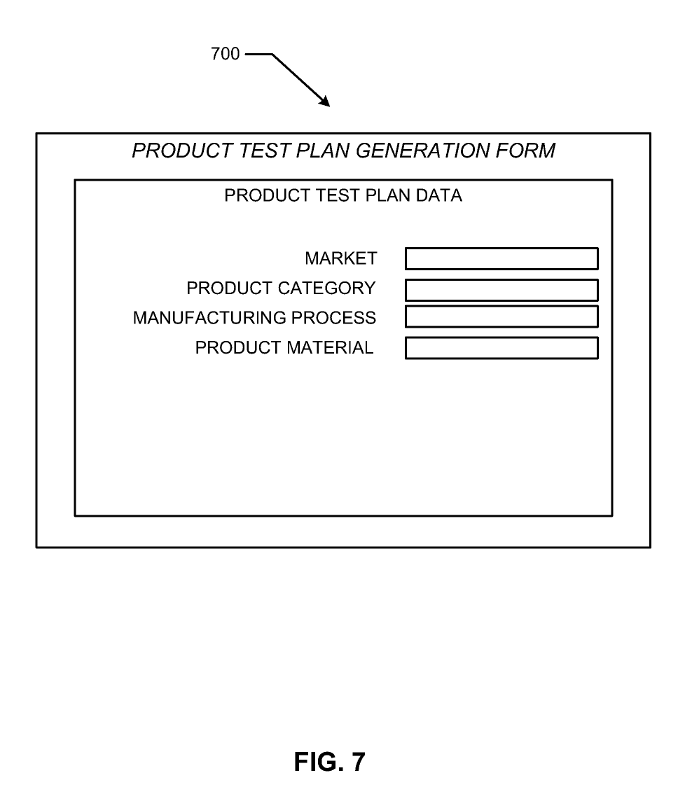

The product input module 306 receives product data, such as product component data for a particular product from a party in a manufacturing supply chain, such as any one of computing devices 102, 112, 114, 116, 118, and 120. Product components are the basic elements, parts, or pieces that make up a particular product. For example, a jacket may be defined as a product. Product components of the jacket may include: zippers, buttons, draw strings, pockets, screen painting, etc. In another example, a pen may be defined as a product. Product components of the pen may include: a cap, an ink cartridge, a casing, etc. The product input module 306 may receive product data, such as product component data from a computing device, such as the tester computing device 112, or the importer computing device 120, or manufacturer computing device 102. For purposes of illustration, an exemplary product test plan generation form (700) is depicted in FIG. 7.

The test plan generation module 308 conducts a query to the database 310 to retrieve product test parameters corresponding to the product component data received by the product input module 306. Product test parameters may generally include multiple product tests corresponding to a product component of a particular product for a variety of different products. A product test typically refers to an assessment intended to measure the compliance of a product, such as safety and/or usability. For example, product test parameters may include tests for products such as jackets, dolls, supply cleaning product, etc.

In yet another embodiment, product test parameters may include a minimum number of each product that must be tested based on the total volume and the manufacturing period (time) of the product being supplied along a supply chain. Again referring to the example above, if 1 million jacket products were put into the supply chain, product test parameters may include data indicating that at least 150,000 jackets out of the 1 million jackets must be tested. If 200,000 doll products were entered into the supply chain, the product test parameters may include data indicating that at least 3000 dolls must be tested. Finally, if 30,000 liquid cleaning supply products were entered into the supply chain, the product test parameters may include data indicating that 300 liquid cleaning supply products must be tested. After the query, the test plan generation module 308 generates a product testing plan based on the identified product test parameters.

In another aspect, product test parameters may include a frequency indicating the number of times a particular test must be conducted for a particular product. Referring to the example above, the product test parameters may include frequency data indicating that the tests for a jacket product must be conducted every 6 months, data indicating that the tests for a doll product must be conducted every year, and the tests for a liquid cleaning supply product must be conducted every 3 months.

The following is an example execution of the PTPGS 122. The product input module 306 may receive product component data for a product such as a jacket. Thus, the product is the jacket and product components of the jacket may be buttons, fabric type, zippers, etc. The test plan generation module 308 queries the database 310 to identify product test parameters corresponding to the buttons, fabric, and zippers (components) of the jacket product. For example, a test to determine whether the fabric is non-flammable, the frequency for how many times the flammability test must be conducted, and the number of jackets that must be tested, may all be identified from the product test parameters. As another example, a test to determine whether the buttons present a choking hazard may be identified. In yet another example, a test to determine the lead content of the zippers may be identified. Subsequently a product testing plan is generated based on the flammability test, the small part test, the lead content test, the frequency data for each test, and the number of products to be tested by each test.

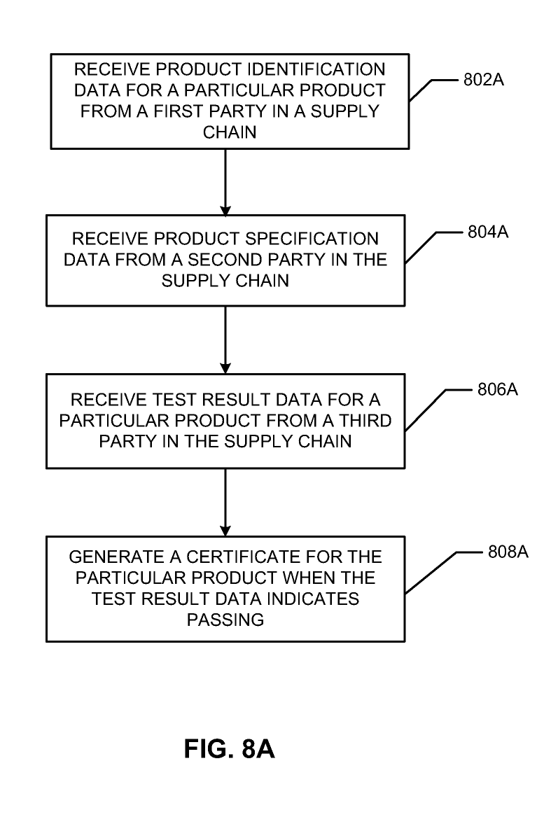

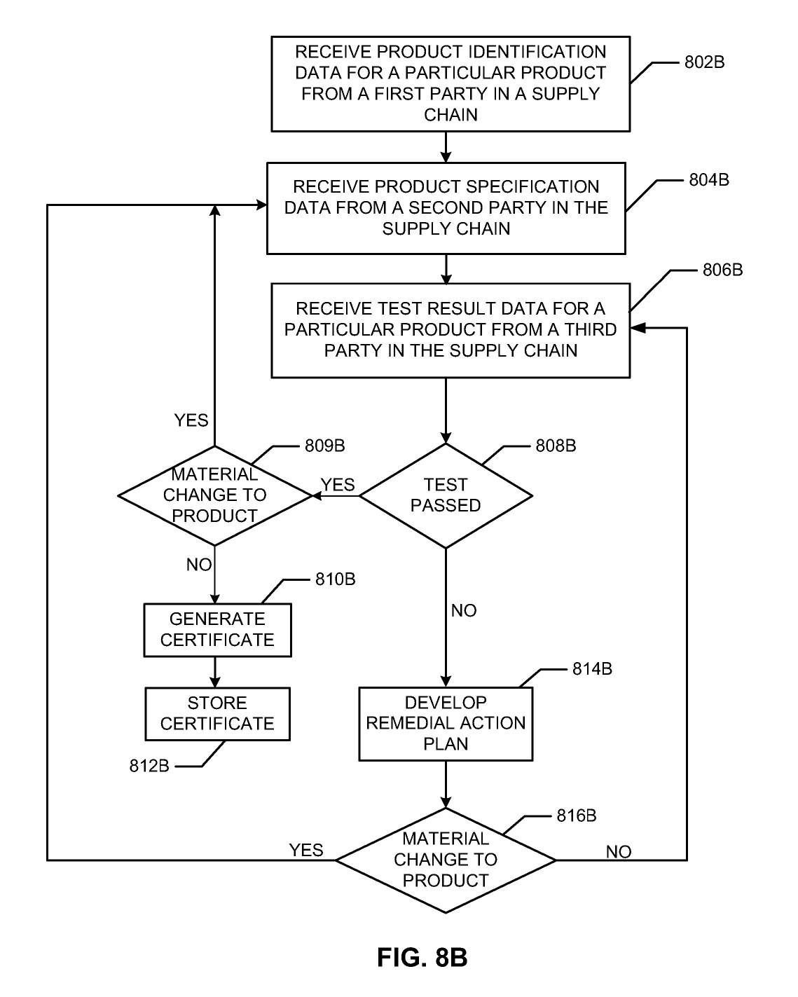

FIG. 8A depicts an exemplary method for product certification according to an example embodiment. At 802A, product identification data for a particular product is received at the product certification system 106 or product specification data for the particular product is received at the product certification system 106 at 804A. At 806A, test result data for the particular product is received at the product certification system 106 from the tester computing device 112. At 808A a certificate for the particular product is generated when the test result data indicates passing result.

FIG. 8B depicts another exemplary method for product certification according to an example embodiment. At 802B, product identification data for a particular product is received at the product certification system 106. Product specification data for the particular product is received at the product certification system 106 at 804B. At 806B, test result data including a test result for the particular product is received at the product certification system 106 from the tester computing device 112. The product certification system 106 determines whether the test result data indicates a passing result at 808B. If a passing result is determined at 808B, the product certification system 106 determines whether there was a material change to the product at 809B. If no material change to the product is determined at 809B, the product certification system 106 may generate a certificate for the particular product at 810B. At 812B, the product certification system 106 stores the certificate in, for example, a database. If a material change to the product is determined, the product certification system 106 may again receive product specification data from a second party in the supply chain at 804B. If a passing result is not determined at 808B, the product certification system 106 may develop a remedial action plan at 814B.

At 816B, the product certification system 106 determines if a material change is required to a product. If no material change is required at 816B, the product certification system 106 receives test result data for a particular product from a third party in the supply chain at 806B. If a material change is required at 816B, the product certification system 106 receives product specification data from a second party in the supply chain at 804B.

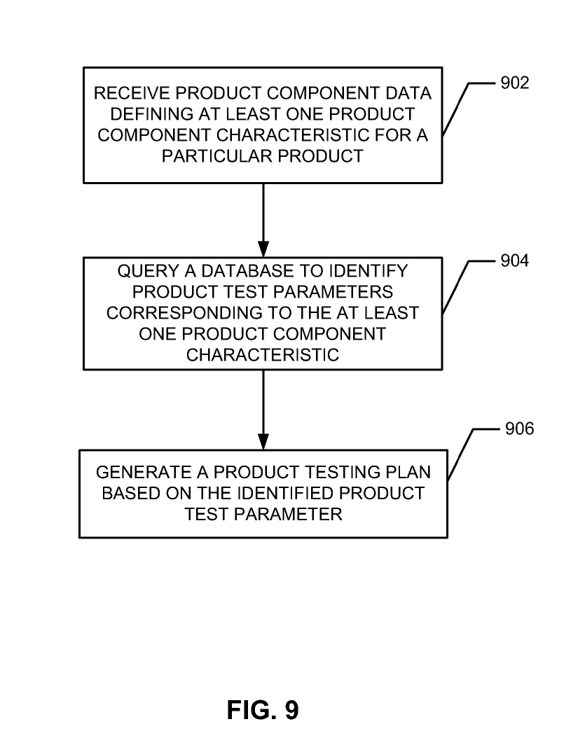

FIG. 9 depicts the PTPGS 122 during execution. At 902, the PTPGS 122 receives product component data defining at least one product component characteristic for a particular product at the PTPGS 122 from any one of computing devices 102, 112, 114, 116, 118, and 120. The PTPGS 122 queries a database to identify product test parameters corresponding to the product component characteristic at 904. At 906, PTPGS 122 generates a product testing plan based on the identified product test parameters

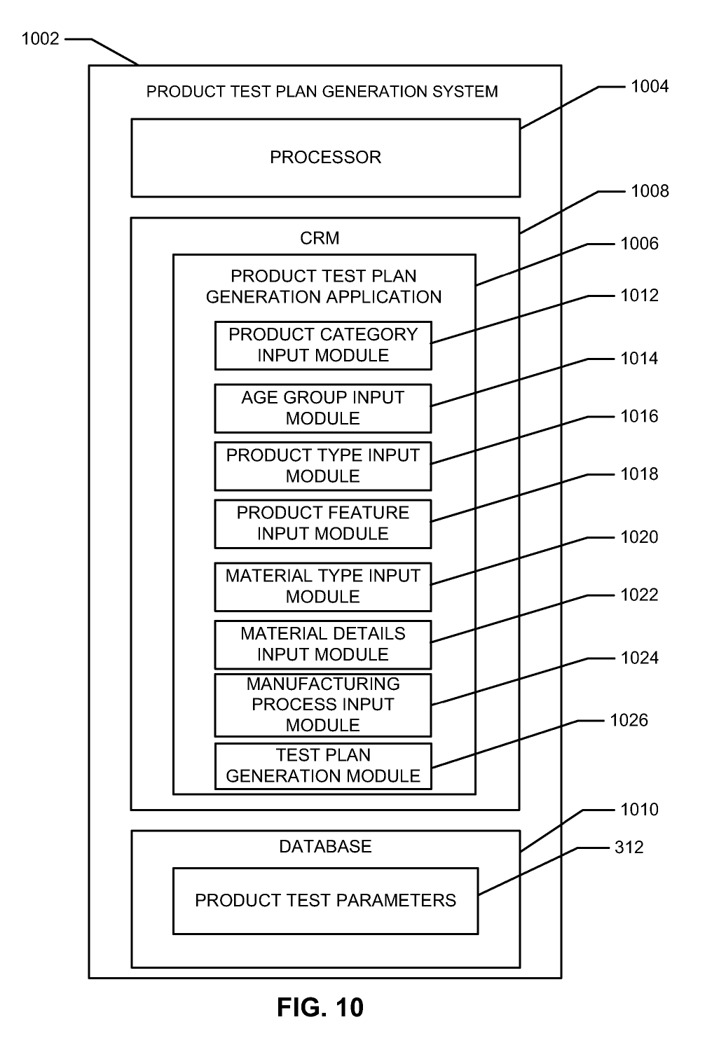

FIG. 10 is a block diagram that depicts another exemplary PTPGS 1002 (e.g. PTPGS 122E). According to one aspect, the PTPGS 1002 includes a processor 1004 that executes a product test plan generation application 1006 to generate a product testing plan for a particular product. The processor 1004 may include memory as well as other computing components and may reside on a computer, or other processing system.

The PTPGS 1002 may also include a computer readable media (“CRM”) 1008 configured with the product test plan generation application 1006. The PTPGS 1002 may include a database 1010 to store product data such as product test parameters 312 for a plurality of products.

According to one aspect of the invention, the product test plan generation application 1006 includes instructions or modules that are executable by the processor 1004. For example, in one embodiment, the product test plan generation application 1006 includes a product category input module 1012, an age grade input module 1014, a product type input module 1016, a product feature input module 1018, a material type input module 1020, a material details input module 1022, a manufacturing process input module 1024, and a test plan generation module 1026. Other modules may also be included.

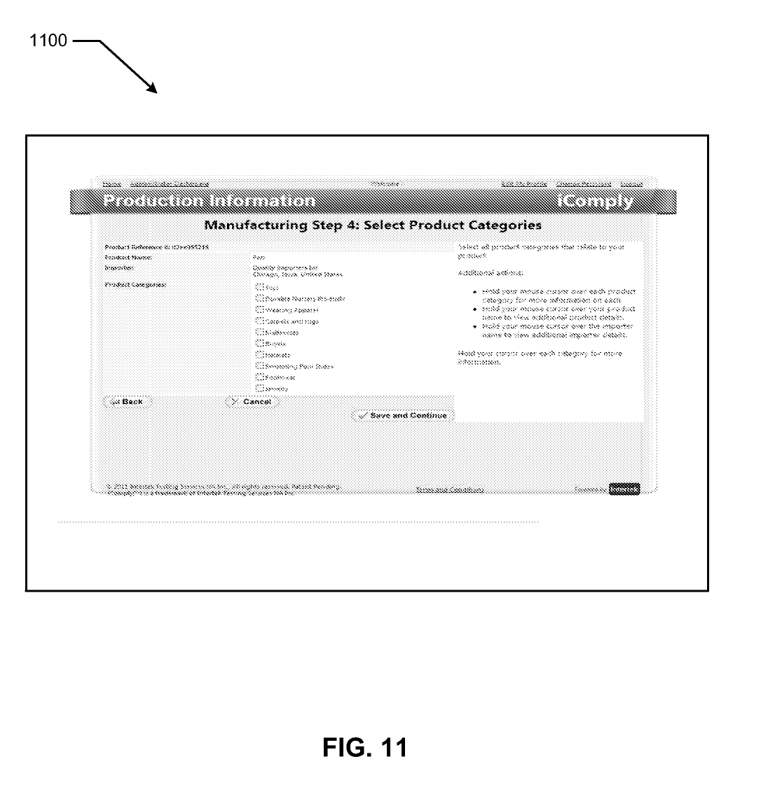

The product category input module 1012 generates a product category selection form 1100 that is displayed at a computing device (e.g., computing devices 102, 112, 114, 116, 118, and/or 120) to receive product category data for a particular product from a party in a manufacturing supply chain. The product category selection form 1100 includes multiple product category input controls that each correspond to different product categories to receive product data defining a particular category of product. The party in the manufacturing chain can interact with a particular product category control in the product category selection form 1100 to select a desired product category. For example, the product category selection form 1100 may include a corresponding checkbox control for each of the following types of product categories: toys, durable nursery products; wearing apparel; carpet and rugs; mattresses; bicycles; helmets; swimming pool slides; foot wear; jewelry; etc. For purposes of illustration, an exemplary product category selection form (1100) is depicted in FIG. 11.

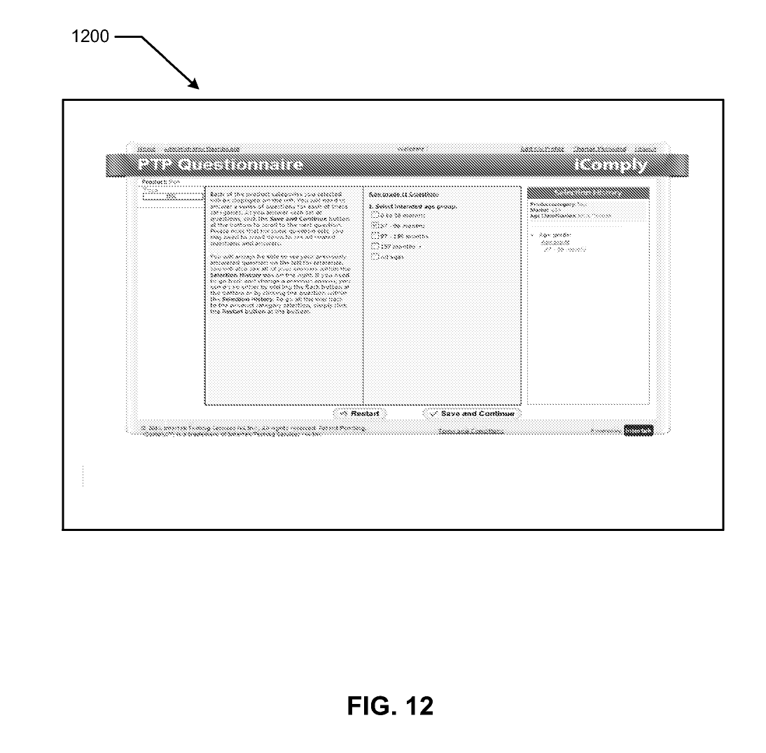

The age grade input module 1014 generates an age selection form 1200 that is displayed at the computing device in response to the party in the manufacturing chain selecting, for example, a “save and continue” control displayed on the product category selection form 1100. The age selection form 1200 includes multiple age input controls that each correspond to a particular age range or age group for a particular product. The party in the manufacturing chain can interact with a particular age input control in the age selection form 1200 to select a desired age range or group. For example, the age selection form 1200 may include a corresponding checkbox control for each of the following age ranges: 0 to 36 months; 37 to 95 months; 97-156 months; 157 months +; and all ages, etc. For purposes of illustration, an exemplary age selection form 1200 is depicted in FIG. 12.

According to one aspect, the age input controls that are displayed in the age selection form 1200 depend on the one or more product categories selected in the product category selection form 1100. For example, the age input module 1014 queries an age range table (not shown) that is stored in the database 1010 to identify the age ranges to display in the age selection form 1200. The age range table identifies, for example, each age range that corresponds to a selected product category.

According to another aspect, the age selection form 1200 may display data previously provided by a user such as product category data.

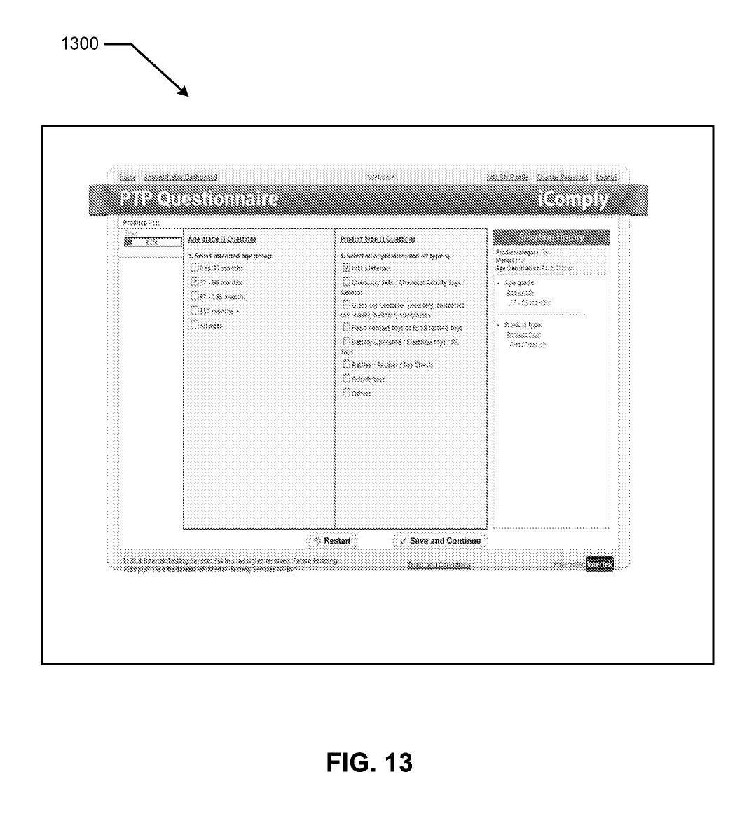

The product type input module 1016 generates a product type selection form 1300 that is displayed at the computing device to receive product type data for a particular product from a party in a manufacturing supply chain. The product type selection form 1300 includes multiple product type input controls that each correspond to different product types to receive product type data defining a particular type of product. The party in the manufacturing chain can interact with a particular product type input control in the product type selection form 1300 to select a desired product type. For example, product type selection form 1300 may include a corresponding checkbox control for each of the following product types: art materials, chemistry sets, chemical activity toys, Aerosol, dress-up costume, jewelry, cosmetics toys, masks, helmets, sunglasses, food contact toys or food related toys, battery operated, electrical toys, RC toys, rattles, pacifiers, toy chest, activity toys, others, etc. For purposes of illustration, an exemplary product type selection form (1300) is depicted in FIG. 13.

According to one aspect, the product type input controls displayed in the product type selection form 1300 depend on the one or more product categories selected in the product category selection form 1100. For example, the product type input module 1016 queries a product type table (not shown) stored in the database 1010 to identify the product types to display in the product type selection form 1300. The product type table identifies, for example, each product type that corresponds to a selected product category.

According to another aspect, the product type selection form 1300 may display data previously provided by a user such as product category data and age range data.

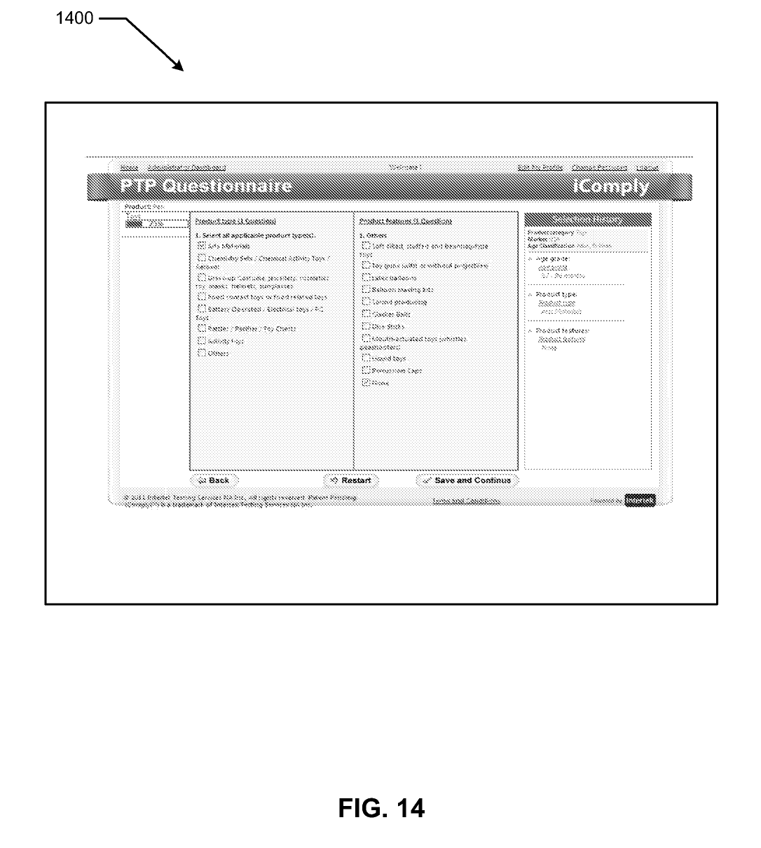

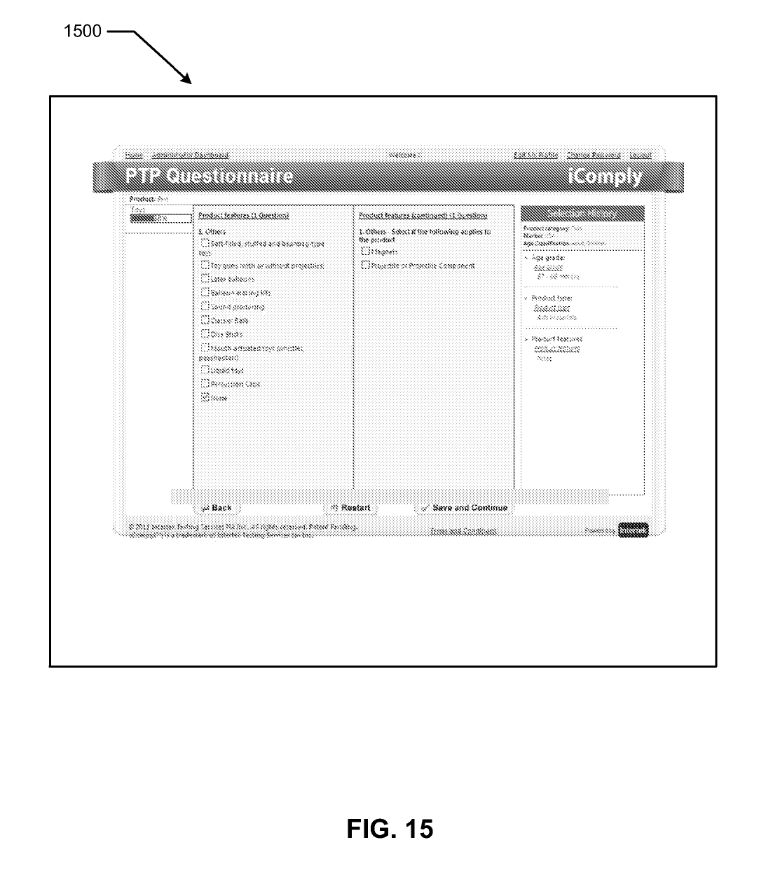

The product feature input module 1018 generates a product feature selection form 1400 that is displayed at the computing device to receive product feature data for a particular product from a party in a manufacturing supply chain. The party in the manufacturing chain can interact with a particular product feature input control in the product feature selection form 1400 to select a desired product feature. For example, product feature selection form 1400 may include a corresponding checkbox control for each of the following types of product features: sort—filled, stuffed and bean-bag type toys, toy guns with projectiles, latex balloons, balloon making kits, sound producing, clacker balls, dive sticks, mouth actuated toys, liquid toys, percussion caps, etc. For purposes of illustration, exemplary product features selection forms 1400 and 1500 are depicted in FIG. 14 and FIG. 15, respectively.

According to one aspect, the product feature input controls that are displayed in the product feature selection form 1400 depend on the one or more product categories selected in the product category selection form 1100. For example, the product feature input module 1018 queries a product type table (not shown) that is stored in the database 1010 to identify the product features to display in the product feature selection form 1400. The product feature table identifies, for example, each product feature that corresponds to a selected product category.

According to another aspect, the product feature selection form 1400 may display data previously provided by a user such as product category data, age range data, and product type data.

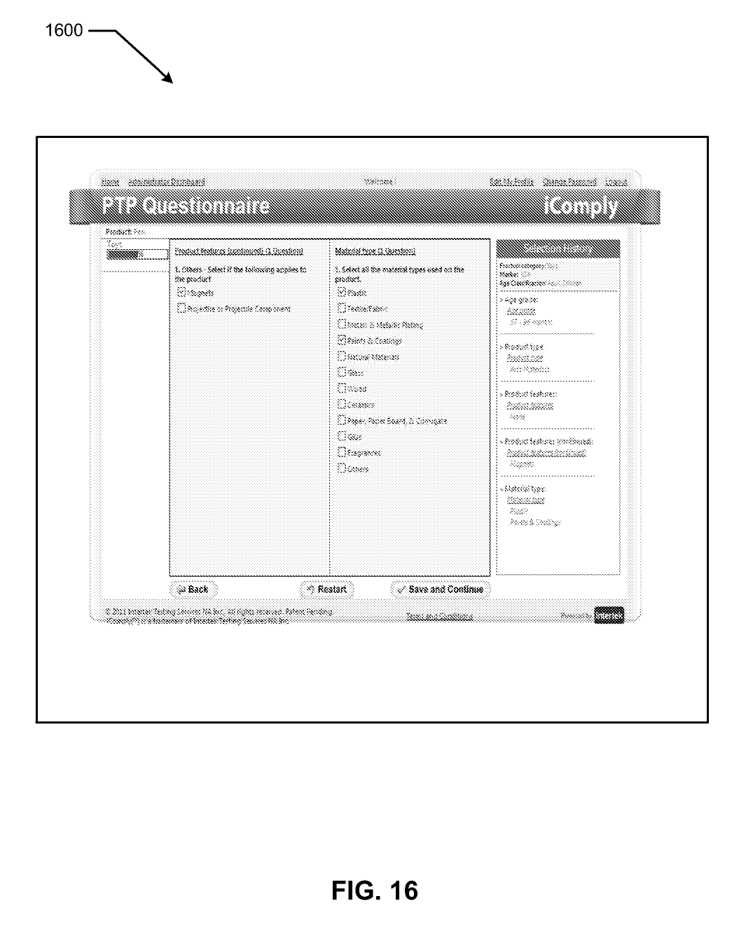

The material type input module 1020 generates a material type selection form 1600 that is displayed at the computing device to receive material type data for a particular product from a party in a manufacturing supply chain. The party in the manufacturing chain can interact with a particular material type input control in the material type selection form 1600 to select a desired material type. For example, material type selection form 1600 may include a corresponding checkbox control for each of the following types of materials: plastic, textile/fabric, metals and metallic plating, paints and coating, natural materials, glass, wood, ceramics, paper, glue, fragrances, etc. For purposes of illustration, an exemplary material type selection form 1600 is depicted in FIG. 16.

According to one aspect, the material type input controls that are displayed in the material type selection form 1600 depend on the one or more product categories selected in the product category selection form 1100. For example, the material type input module 1020 queries a material type table (not shown) stored in the database 1010 to identify the material types to display in the material type selection form 1600. The material type table identifies, for example, each material type that corresponds to a selected product category.

According to another aspect, the material type selection form 1600 may display data previously provided by a user such as product category data, age range data, product type data, and product feature data.

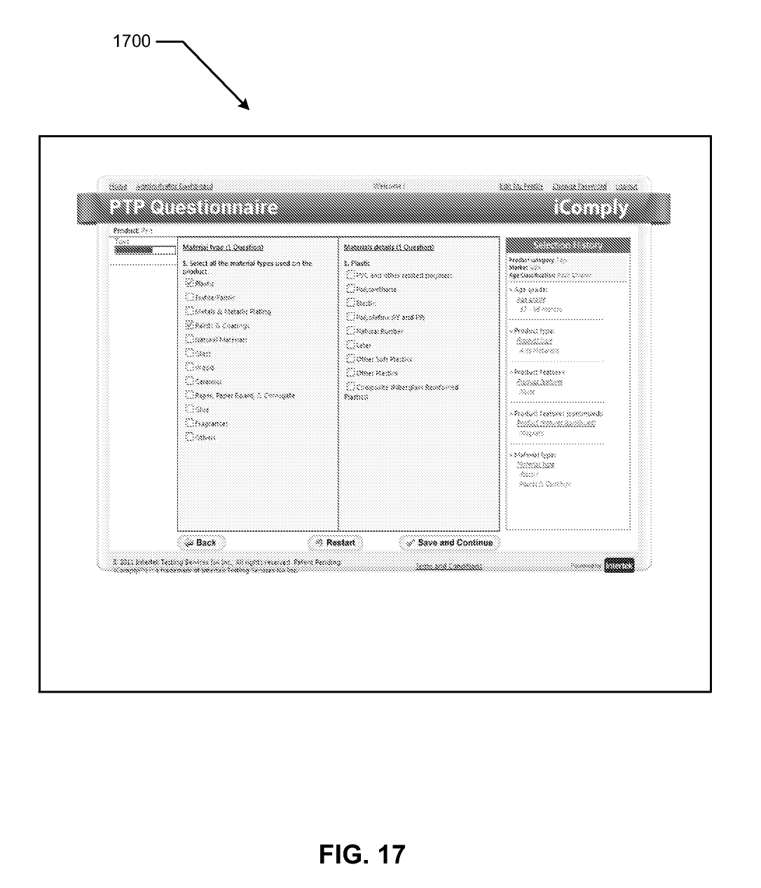

The material details input module 1022 generates a material details selection form 1700 that is displayed at the computing device to receive material details data for a particular product from a party in a manufacturing supply chain. The party in the manufacturing chain can interact with a particular material details input control in the material details selection form 1700 to select a desired material detail. For example, material details selection form 1700 may include a corresponding checkbox control for each of the following types of material details: PVC and related polymers, polyurethane, elastic, polyolefins (PE and PP), Natural rubber, latex, other soft plastics, other plastics, composite plastics (fiberglass reinforced plastics), etc. For purposes of illustration, an exemplary material details selection form 1700 is depicted in FIG. 17.

According to one aspect, the material details input controls that are displayed in the material details selection form 1700 depend on the one or more product categories selected in the product category selection form 1100. For example, the material details input module 1022 queries a material details table (not shown) that is stored in the database to identify the material details to display in the material details selection form 1700. The material details table identifies, for example, each material detail that corresponds to a selected product category.

According to another aspect, the material details selection form 1700 may display data previously provided by a user such as product category data, age range data, product type data, product feature data, and material type data.

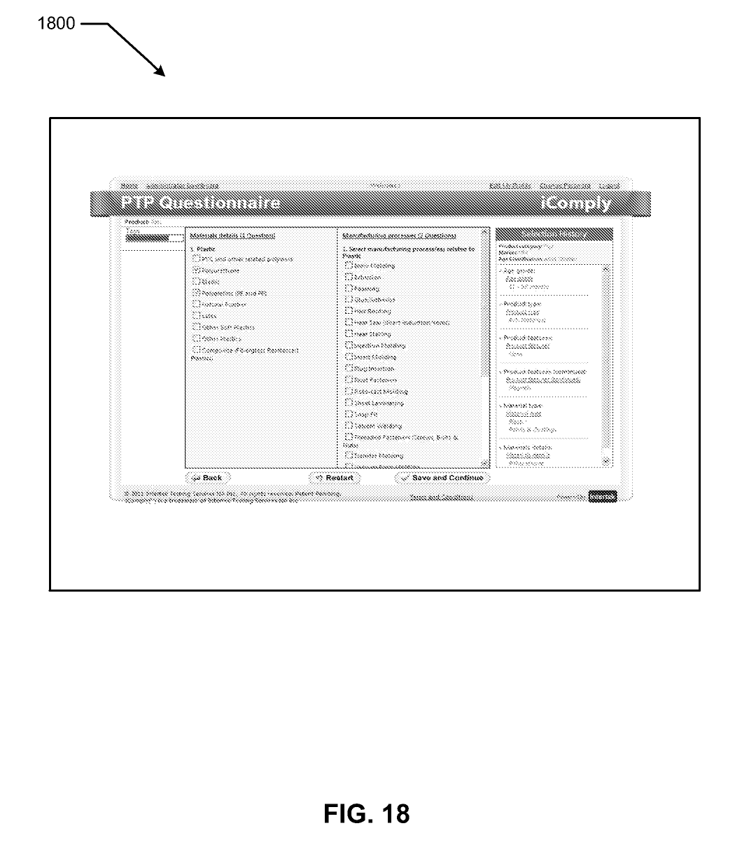

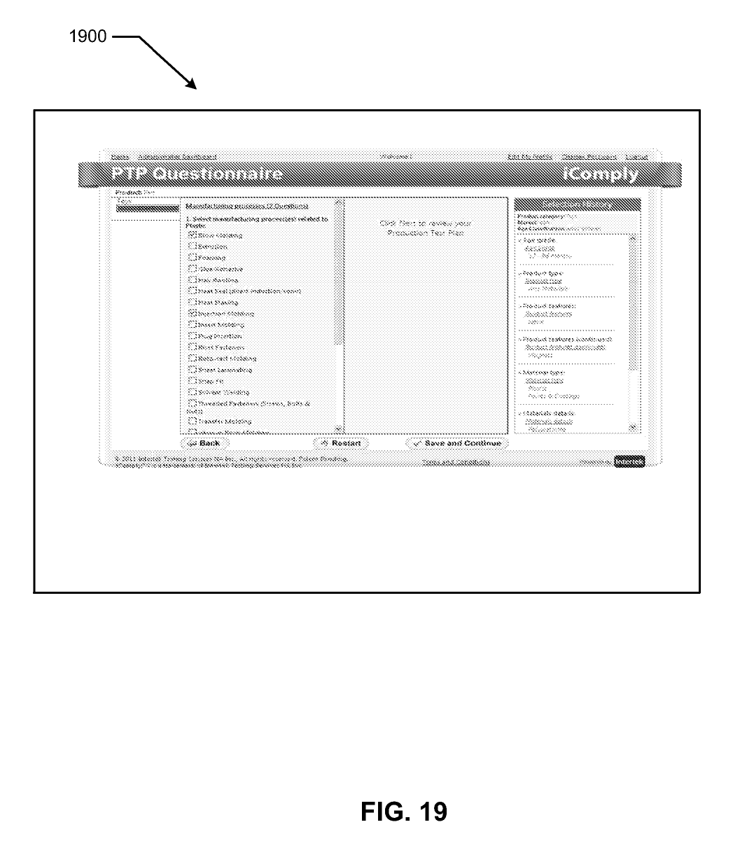

The manufacturing processes input module 1024 displays a manufacturing process selection form 1800 that is displayed at the computing device to receive manufacturing process data for a particular product from a party in a manufacturing supply chain. The party in the manufacturing chain can interact with a particular manufacturing process input control in the manufacturing process selection form 1800 to select a desired material detail. For example, the manufacturing process selection form 1800 may include a corresponding checkbox control for each of the following types of manufacturing processes: blow molding, extrusion, foaming, glue/adhesive, hair rooting, heat seal (direct induction/sonic), heat staking, injection molding, insert molding, plug insertion, rivet fasteners, roto-casting molding, sheet laminating, snap fit, solvent welding, threaded fasteners (screws, bolts, and nuts), transfer molding, etc. For purposes of illustration, exemplary manufacturing process selection forms 1800 and 1900 are depicted in FIG. 18 and FIG. 19, respectively.

According to one aspect, the manufacturing process input controls that are displayed in the manufacturing process selection form 1800 depend on the one or more product categories selected in the product category selection form 1100. For example, the manufacturing process input module 1024 queries a manufacturing process table (not shown) that is stored in database to identify the manufacturing process to display in the manufacturing process selection form 1800. The manufacturing process table identifies, for example, each manufacturing process that corresponds to a selected product category.

According to another aspect, manufacturing process selection form 1800 may display data previously provided by a user such as product category data, age range data, product type data, product feature data, material type data, material details data, and manufacturing process data.

The test plan generation module 1026 conducts a query to the database 1010 to retrieve product test parameters based on the data entered into the product category input module 1012, age grade input module 1014, product type input module 1016, product feature input module 1018, material type input module 1020, material details input module 1 022, and/or the manufacturing process input module 1024. The retrieved product test parameters include, for example, relevant tests that can be used to certify that a particular product is in compliance with any applicable requirements and/or regulations based on the data entered into the product category input module 1012, age grade input module 1014, product type input module 1016, product feature input module 1018, material type input module 1020, material details input module 1022, and/or the manufacturing process input module 1024.

After the query, the product test plan module 1026 determines the requirements and categorization risk for a particular product and generates a product testing plan based on the identified product test parameters 312. The corresponding product test parameters may also include a frequency of testing and a number of products to be tested.

Those skilled in the art will appreciate that variations from the specific embodiments disclosed above are contemplated by the invention. The invention should not be restricted to the above embodiments, but should be measured by the following claims.

What is claimed is:

1. A system for generating a product testing plan comprising:
at least one processor;
a database comprising product test parameters for a plurality of products;
a product test application comprising modules executable by the at least one processor, the modules comprising:
a product input module to receive product component data for a particular product, the product component data defining at least one product component characteristic; and
a test generation module to:
query the database to identify product test parameters corresponding to the at least one product component characteristic; and
generate a product testing plan based on the identified product test parameters corresponding to the at least one product component characteristic.

2. The system for generating a product testing plan of claim 1, wherein the product component characteristic defines a product feature or a product manufacturing process.

3. The system for generating a product testing plan of claim 1, wherein the product test parameters is generated based on at least one regulation and a statistical analysis of the variability and failure rates of the particular product based on at least one of a manufacturing process and a product category, and wherein the product test parameters comprises a test type, a test frequency, and a sample amount for each of the plurality of products, the sample amount identifying a minimum number of each product to test based on a total volume of that product being supplied along a supply chain and the sample amount being randomly selected from the total volume of the product being supplied along the supply chain.

4. A method for generating a product testing plan comprising:
receiving, at a processor, product component data for a particular product, the product component data defining at least one product component characteristic;
querying, at the processor, a database comprising product test parameters for a plurality of products the database to identify product test parameters corresponding to the at least one product component characteristic; and
generating, at the processor, a product testing plan based on the identified product test parameters corresponding to the at least one product component characteristic.

5. The method of claim 4, wherein the product component characteristic defines a product feature or a product manufacturing process.

6. The method of claim 4, wherein the product test parameters are generated based on at least one regulation and a statistical analysis of the variability and failure rates of the particular product, and wherein the product test parameters comprises a test type, a test frequency, and a sample amount for each of the plurality of products, the sample amount identifying a minimum number of each product to test based on a total volume of that product being supplied along a supply chain and the sample amount being randomly selected from the total volume of the product being supplied along the supply chain.

7. A system for generating a product testing plan comprising:
a database comprising product test parameters for a plurality of products;
a product test application comprising modules executable by a processor, the modules comprising:
a product category input module to receive product category data for a particular product, the product category data defining at least one product category;
an age grade input module to receive age grade data for a particular product, age grade data defining at least one age range;
a product type input module to receive product component data for a particular product, the product type data defining at least one product type;
a product features input module to receive product feature data for a particular product, the product feature data defining at least one product feature;
a material type input module to receive material type data for a particular product, the material type data defining at least one material type;
a material details input module to receive material details data for a particular product, the material details data defining at least one material detail;
a manufacturing process input module to receive manufacturing process data for a particular product, the manufacturing process data defining at least one manufacturing process; and
a test plan generation module to:
query the database to identify product test parameters corresponding to the at least one product category, age grade, product type, product feature, material type, material detail, and manufacturing process; and
generate a product testing plan based on the identified product test parameters corresponding to the at least one product category, age grade, product type, product feature, material type, material detail, and manufacturing process.

8. The system for generating a product testing plan of claim 7, wherein the product test parameters are generated based on at least one regulation and a statistical analysis of the variability and failure rates of the particular product based on at least one of a manufacturing process and a product category, and wherein the product test parameters comprises a test type, a test frequency, and a sample amount for each of the plurality of products, the sample amount identifying a minimum number of each product to test based on a total volume of that product being supplied along a supply chain and the sample amount being randomly selected from the total volume of the product being supplied along a supply chain.
